(19) United States
(12) Patent Application Publication
(10) Pub. No.: US 2005/0263634 A1
(43) Pub. Date: Dec. 1, 2005

(54) Crushing device for bulk-material particles

(76) Inventor: Martin Rothmann, Ebsdorfergrund (DE)

Correspondence Address: REED SMITH LLP, 3110 Fairview Park Drive, Suite 1400, Falls Church, VA, 22042, US

(21) Appl. No.: 11/135,568

(22) Filed: May 24, 2005

(30) Foreign Application Priority Data
May 25, 2004 (DE) 10 2004 026 068.0

(51) Int. Cl. B02C 18/16

(52) U.S. Cl. 241/236

(57) ABSTRACT

A crushing device (10) for crushing cut material (35), especially granular or fibrous particles comprising at least two crushing rollers (12, 13) driven in opposite directions between which is formed at least one engagement pairing of a radial cross-piece of one roller and a radial groove of the other roller, whose flanks are arranged parallel and at an angle 0<α<90° to the longitudinal axes (19, 20) of the rollers such that a parallel gap is formed between two neighbouring flanks, wherein the flanks are provided with a threaded profile.

The present invention relates to a crushing device for crushing bulk-material particles, especially granular or fibrous particles, comprising at least two crushing rollers driven in opposite directions between which is formed at least one engagement pairing of a radial cross-piece of one roller and a radial groove of the other roller, whose flanks are arranged parallel and at an angle 0<α<π° to the longitudinal axes of the rollers such that a parallel gap is formed between two neighbouring flanks.

Crushing devices of the type specified initially are used, for example, as so-called after-crushing devices for further crushing of chaff material. This can comprise, for example, harvested material or also finely crushed fibrous organic material used for composting in biocompost plants or for charging biogas plants.

A further area of application for crushing devices of the type specified initially is their use as a grinding device to crush cereals or to break up corresponding granular particles to improve the quality of granular animal fodder. For example, it is known to treat oats before feeding in a so-called oat crusher where the oat grain is broken up by crushing.

In the aforesaid types of usage, particular problems arise during operation of the known crushing devices according to whether the material to be crushed comprises granular or fibrous particles. In the case of granular particles, a non-uniform crushing effect is frequently obtained so that some grains are only slightly crushed whereas others are completely destroyed by the pressure in the roll gap.

Depending on the moisture content of the grain used, sticking can also occur in the roll gap which hinders the throughput. The risk of the roll gap clogging as a result of non-uniform crushing and a relatively high residual moisture content exists especially when crushing fibrous material which has not been sufficiently dehydrated.

It is the object of the present invention to propose a crushing device which remedies the aforesaid problems and especially makes it possible to achieve a high throughput as a consequence of a uniform crushing effect.

This object is solved by a crushing device having the features of claims 1.

In the crushing device according to the invention, the flanks defining the parallel roll gap are provided with a threaded profile.

As a result of the profiling of the flanks as such, the effective gap length between the flanks is lengthened which has an advantageous effect on the possible throughput. In addition, the formation of the profiling as a threaded profile ensures an increased shear effect between the flanks when the flanks are rotating in opposite directions since the threads define shear edges.

A particularly high shear effect can be achieved if the thread profiles of the flanks delimiting the parallel gap are constructed as running in opposite directions so that the thread profile of one flank defines a right-hand thread and the thread profile of the opposing flank defines a left-hand thread.

If the radial cross-piece has a double-wedge profile which engages in a complementarily shaped radial groove having a V-shaped profile, the length of the parallel gap can be doubled over a short length of the crushing rollers.

If a plurality of engagement pairings is constructed such that both rollers have a plurality of radial cross-pieces and radial grooves in alternating sequence and in uniform spacing which alternately enter into engagement with one another so that the radial cross-pieces of one roller engage in the radial grooves of the other roller and conversely, the entire available length of the crushing roller can be used particularly effectively.

In order to ensure that the entire quantity of bulk material provided for the crushing. is conveyed through the roller gap, the rollers can each be provided with a stripping device which defines an intake gap and is constructed as complementary to the longitudinal profile of the rollers.

In order to make it possible to achieve a defined crushing of the bulk material provided for crushing, at least one of the crushing rollers can be provided with a feed device acting perpendicular to the longitudinal axis of the other crushing roller.

In a further embodiment of the crushing device, the threaded profile is provided with at least one entrainment edge running transversely to a course of thread so that in particular the intake of relatively large-grained particles or bulk material particles which especially exhibit a particular hardness as a result of their dehydrated state, into the parallel gap or the crushing in the parallel gap is improved. The entrainment edge thus has a double function, namely on the one hand, an improved entrainment of the supplied particles into the parallel gap and on the other hand a cutting effect to achieve an improved crushing effect. The afore-mentioned particles can, for example, comprise maize grains, soya beans or peas. In principle, however, an improved crushing effect can also be determined for fine-grained cereals such as wheat, oats or barley, for example.

A particularly good entrainment effect and also a particularly good cutting effect can be achieved if the entrainment edge is formed by a cutting surface arranged inclined at an angle β to the engagement flank.

Furthermore, if a plurality of entrainment edges form a linear entrainment arrangement which extends over the engagement flank, it is possible to achieve the effects described previously in the entire parallel gap.

It has proved advantageous for the effect of the entrainment edges if the entrainment arrangement is aligned radially.

If a plurality of entrainment arrangements is constructed distributed on the engagement flank which are especially advantageously arranged equidistantly, a particularly advantageous design is achieved both with regard to the intake conditions into the parallel gap and with regard to the crushing performance.

A preferred embodiment of the crushing device is explained in detail subsequently with reference to the drawings.

In the figures:

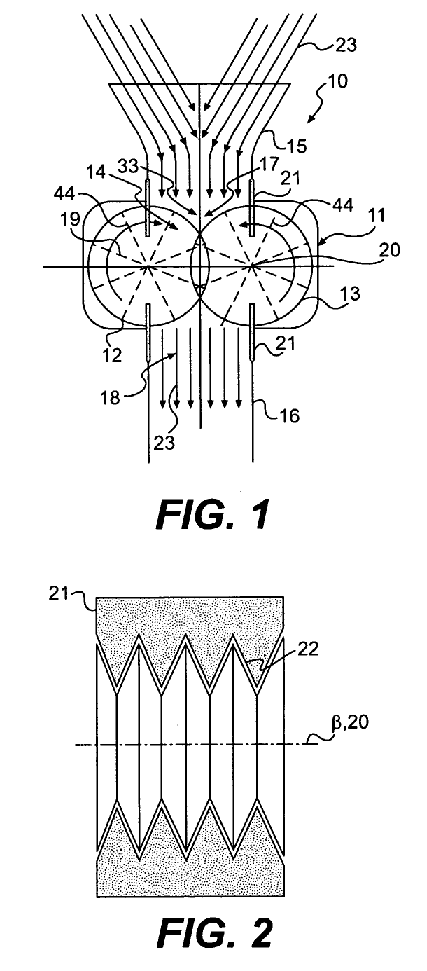

FIG. 1 is a schematic diagram of a crushing device comprising two crushing rollers driven in opposite directions as well as an intake hopper and an output shaft;

FIG. 2 is a partial side view of the crushing device shown in FIG. 1;

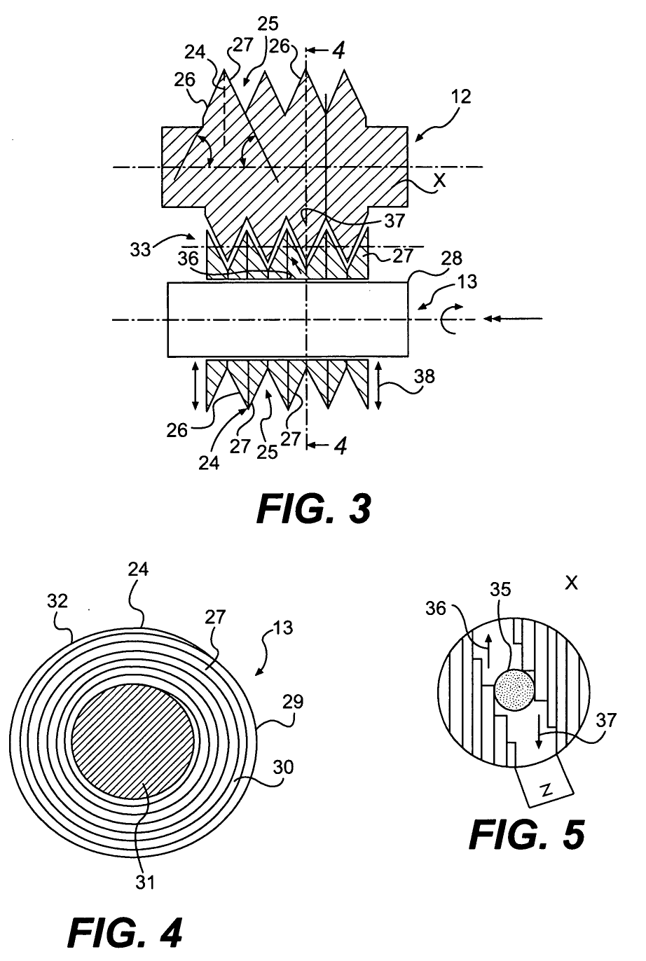

FIG. 3 is a diagram of the crushing rollers located in engagement with one another with a parallel gap formed between the crushing rollers;

FIG. 4 is a sectional view of a crushing roller according to the line of intersection IV-IV in FIG. 3;

FIG. 5 is an enlarged view of the section of the parallel gap formed between the crushing rollers identified as X in FIG. 3;

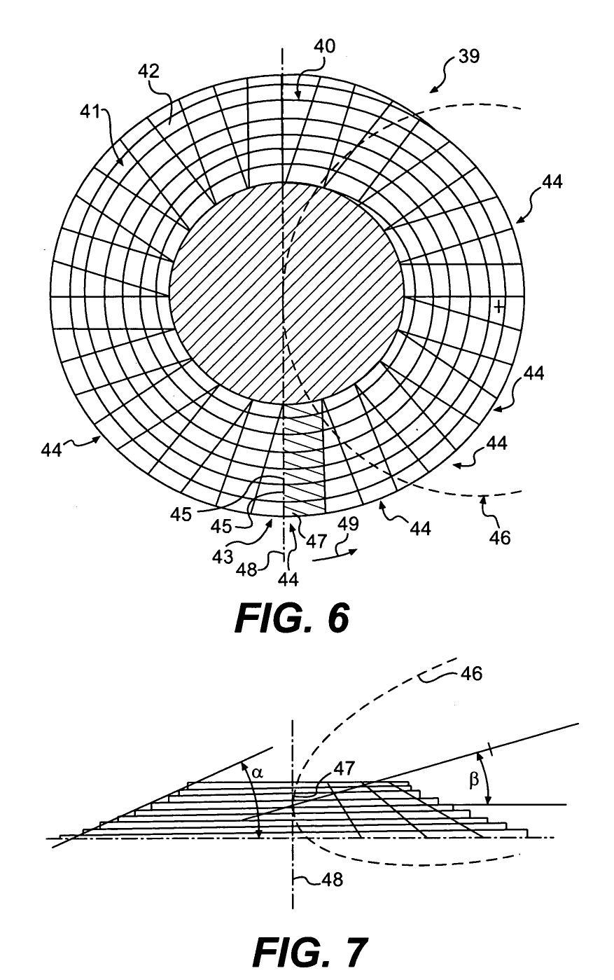

FIG. 6 is a sectional view of a crushing roller according to FIG. 4 with an entrainment device constructed on one engagement flank;

FIG. 7 is a side view of the engagement flank shown in FIG. 6.

FIG. 1 shows a crushing device 10 comprising two crushing rollers 12, 13 arranged in a common machine housing 11, which are driven in opposite directions according to the arrows indicating the direction rotation such that in the exemplary embodiment the crushing roller 12 shown on the left in FIG. 1 is driven clockwise and the crushing roller 13 shown on the right in FIG. 1 is driven anticlockwise. As is further shown in FIG. 1, an intake hopper 15 is arranged above an engagement region 14 of the crushing rollers 12, 13 on the machine housing 11 and an ejection connecting piece 16 is constructed below the engagement region 14. For sealing an intake region 17 above the engagement region 14 and an ejection region 18 below the engagement region 14 with respect to the machine housing 11, both crushing rollers 12, 13 are provided with stripping devices 21 parallel to the longitudinal axes 19, 20 of the rollers, which, as shown in FIG. 2, engage with stripping tongues 22 in the longitudinal profile of the crushing rollers 12, 13. The stripping devices 21 especially prevent bulk material 23 inserted in the intake hopper 15, in this case granular material for example, from penetrating into the machine housing 11 in the intake region 17 or the ejection region 18.

FIG. 3 shows the crushing rollers 12, 13 arranged so that they intermesh in their engagement region 14, shown in cross-section, viewed in the direction of supply of the bulk material 23.

As shown in FIG. 3, in their longitudinal profile the crushing rollers 12, 13 are defined by an alternating arrangement of radial cross-pieces 24 and radial grooves 25 which are bounded by engagement flanks 26, 27 arranged obliquely to the longitudinal axes 19, 20 of the rollers. The engagement flanks 26, 27 are each set in pairs obliquely with respect to one another so that in the exemplary embodiment shown, in the longitudinal sectional view of the crushing rollers 19, 20 selected in FIG. 3 the radial cross-pieces 24 have a double-wedge profile with a wedge angle a measured with respect to the longitudinal axes 19, 20 of the rollers which is about 60° in the present case. As is shown clearly in FIG. 3, a sawtooth-shaped longitudinal profile of the crushing rollers 12, 13 is formed by the alternating arrangement of radial cross-pieces 24 interrupted by radial grooves 25.

As shown in FIG. 3, the afore-mentioned sawtooth-shaped longitudinal profile of the crushing rollers 12, 13 can be produced in different ways. The crushing roller 12 can be constructed in one piece, as is shown for the example of the crushing roller 12 or the crushing roller 13 can be produced by an alternate arrangement of disks 27 on a shaft 28 as shown for the example of the crushing roller 13.

As can be seen from the sectional view of the crushing roller 13 shown in FIG. 4, in the present case the engagement flank 27 of the radial cross-piece 24 is provided with a right-hand thread 29 such that a thread 30 extends on the engagement flank 27 from a shaft cross-section 31 of the crushing roller 13 to an external circumference 32 of the radial cross-piece 24. As a result of the alternate engagement of the radial cross-pieces 24 of one crushing roller 12 and the radial grooves 25 of the associated crushing roller 13 in the engagement region 17, the zigzag profile of a parallel gap 33 shown in FIG. 3 is obtained between the crushing rollers 12, 13. FIG. 5 shows an enlarged section of the parallel gap section 34 with an interposed arrangement of a bulk material particle 35, embodied here as a grain particle, in order to explain the relationships in a parallel gap section 34.

As is indicated by the direction arrows 36, 37 in the parallel gap section 34 in FIG. 3, the engagement flanks 26, 27 defining the parallel gap section 34 have oppositely oriented threads 29 so that in relation to the direction of rotation of the crushing roller 13 in the clockwise direction, the thread on the engagement flank 27 of the crushing roller 13 is constructed as right-hand and the thread of the opposing engagement flank 26 in the parallel gap section 34 during rotation of the crushing roller 12 in the anticlockwise direction is constructed as left-hand. As shown in FIG. 5, this produces high shear forces in the bulk material particle 35 as a result of the oppositely directed direction of the rotation of the threads 30, which ensure that the bulk material particle 35 is broken up.

For adjusting the gap width Z shown in FIG. 5, the crushing roller 13 shown in FIG. 3 is provided with a feed device 38 which makes it possible to achieve a parallel feed movement of the crushing roller 13 towards or away from the crushing roller 12 relative to the longitudinal axes 19, 20 of the rollers. This makes it possible to adjust the optimal gap width Z for the respective size of bulk material particle 35.

As can be seen from the sectional view of a crushing roller 39 shown in FIG. 6 which can preferably be used combined with a further crushing roller constructed in the same manner in accordance with the crushing roller pairing of the crushing rollers 12, 13 shown in FIG. 1, the crushing roller 39 has an engagement flank 40 which, in agreement with the crushing roller 13 shown in FIG. 4, has a right-hand thread 41 such that a thread 42 extends on the engagement flank 40 from a shaft cross-section 31 of the crushing roller 39 to an outer circumference 32 of the radial cross-piece 24.

In contrast to the thread 30 shown in FIG. 4, the thread 42 of the crushing roller 39 is provided with an entrainment device 43 which has a plurality of radially running entrainment arrangements 44. The entrainment arrangement 44 has entrainment edges 45 arranged in radial alignment with one another which are constructed in all windings of the thread 42. Of the plurality of entrainment arrangements 44, FIG. 6 shows only one entrainment arrangement 44 as an example where a cutting tool constructed as a saw-blade 46 with an indicated outline is shown at the same time to explain the construction of the entrainment arrangement 44. The cutting surfaces 47 formed by using the cutting tool embodied here as a saw-blade 46 whilst producing the entrainment arrangements 44 are shown both in FIG. 6 and in the side view of the engagement flank 40 in FIG. 7. As can be seen clearly from viewing FIGS. 6 and 7 together, to produce the entrainment arrangements 44 the rotating saw-blade 46 is guided along a radius 48 inclined in accordance with the wedge angle α wherein the saw-blade 46 is inclined at the angle β to the plane of the engagement flank 40.

This produces the cutting surfaces 47 shown shaded in FIGS. 6 and 7, which are oriented at the angle β to the plane of the engagement flank 40. The entrainment edges 45 formed hereby along the radius 48 form respectively one entrainment arrangement 44 in linear arrangement.

When the crushing roller 39 shown in FIG. 6 rotates in accordance with the direction-of-rotation arrow 49, that is anti-clockwise, as shown in FIG. 6 in each case, particles arranged to the right of the entrainment arrangements 44 or the entrainment edges 45 in the parallel gap 33 (FIG. 1) are gripped and sheared by the counter-rotating entrainment arrangements 44 in the engagement region 14 as indicated in FIG. 1.

1. A crushing device for crushing cut material, especially granular or fibrous particles comprising at least two crushing rollers, driven in opposite directions between which is formed at least one engagement pairing of a radial cross-piece of one roller and radial groove of the other roller, whose flanks are arranged parallel and at an angle 0<α<90° to the longitudinal axes of the rollers such that a parallel gap is formed between two neighbouring flanks,
characterised in that the flanks are provided with a threaded profile.

2. The crushing device according to claim 1,
characterised in that the threaded profiles of the flanks defining a parallel gap are oppositely directed.

3. The crushing device according to claim 1,
characterised in that the radial cross-piece has a double-wedge profile which engages in a complementarily shaped radial groove having a V-shaped profile.

4. The crushing device according to claim 3,
characterised in that a plurality of engagement pairings is constructed such that both rollers have a plurality of radial cross-pieces and radial grooves in alternating sequence and in uniform spacing which alternately enter into engagement with one another.

5. The crushing device according to claim 1,
characterise in that the rollers are each provided with a stripping device defining an intake gap, constructed as complementary to the longitudinal profile of the rollers.

6. The crushing device according to claim 1,
characterised in that at least one crushing roller is provided with a feed device acting perpendicular to the longitudinal axis of the other crushing roller.

7. The crushing device according to claim 1,
characterised in that the threaded profile is provided with at least one entrainment edge running transversely to a course of thread.

8. The crushing device according to claim 7,
characterised in that the entrainment edge is formed by a cutting surface arranged inclined at an angle β to an engagement flank.

9. The crushing device according to claim 7,
characterised in that a plurality of entrainment edges form a linear entrainment arrangement which extends over the engagement flank.

10. The crushing device according to claim 9,
characterised in that the entrainment arrangement runs radially.

11. The crushing device according to claim 9,
characterised in that a plurality of entrainment arrangements is constructed distributed on the engagement flank.

12. The crushing device according to claim 2,
characterised in that the radial cross-piece has a double-wedge profile which engages in a complementarily shaped radial groove having a V-shaped profile.

13. The crushing device according to claim 12,
characterised in that a plurality of engagement pairings is constructed such that both rollers have a plurality of radial cross-pieces and radial grooves in alternating sequence and in uniform spacing which alternately enter into engagement with one another.

14. The crushing device according to claim 8,
characterised in that a plurality of entrainment edges form a linear entrainment arrangement which extends over the engagement flank.

15. The crushing device according to claim 14,
characterised in that the entrainment arrangement runs radially.

16. The crushing device according to claim 10,
characterised in that a plurality of entrainment arrangements is constructed distributed on the engagement flank.

17. The crushing device according to claim 14,
characterised in that a plurality of entrainment arrangements is constructed distributed on the engagement flank.

18. The crushing device according to claim 15,
characterised in that a plurality of entrainment arrangements is constructed distributed on the engagement flank.
